(19) United States
(12) Patent Application Publication
(10) Pub. No.: US 2007/0050943 A1
(43) Pub. Date: Mar. 8, 2007

(54) Free stopping hinge

(76) Inventor: Chin-Te Chiu, Tu-Cheng City (TW)

Correspondence Address: LIN & ASSOCIATES INTELLECTUAL PROPERTY, P.O. BOX 2339, SARATOGA, CA, 95070-0339, US

(21) Appl. No.: 11/221,149

(22) Filed: Sep. 7, 2005

(51) Int. Cl. E05D 11/08

(52) U.S. Cl. 16/342

(57) ABSTRACT

A free stopping hinge includes a sleeve and a rotary shaft. The sleeve has a mating portion with an axial hole defined therein. A wall of the hole has an axial slot and a perpendicular slot being perpendicular to and communicating with the axial slot. Both of the axial slot and the vertical slot penetrate the wall of the axial hole. The rotary shaft has an engaging portion pivotally installed in the axial hole. Constructed as mentioned-above, the present free stopping hinge has a simple structure. The axial slot and the vertical slot help to provide flexibility in engaging the shaft and the sleeve, thereby facilitating assembling of the hinge. The flexibility in turn helps to provide a proper friction as the rotary shaft rotates with respect to the sleeve for free stopping.

### BACKGROUND OF THE INVENTION

1. Field of the Invention

The present invention relates to a hinge, and more particularly, to a free stopping hinge.

2. The Related Art

Now, free stopping hinges are widely used in assembling the machine body of electronic devices, such as notebook computers, personal digital assistants, etc., having two portions which are pivotally connected through a hinge. In these devices, for example, as a display is opened to a position, it can be positioned in that position so as not to fall down due to the gravitational force. In this hinge, the friction between a rotary unit and a stator unit is utilized to resist the twisting force of the gravitational force. If the friction is too large, not only a large force is necessary to open the device, but also a large wearing or a further destroying occurs when the rotary unit rotates with respect to the stator unit. If the friction is too small, it is very possible that one portion slides unrestrainedly with respect to the other portion. Therefore, the frictional force between the rotary unit and the stator unit becomes the key point in designing the free stopping hinge.

In prior art, a type of free stopping hinge is formed through a sleeve having an axial hole and a rotary shaft having an engaging portion pivotally connected in the axial hole of the sleeve. In this type of free stopping hinge, a high precision of the components must be provided, so as to generate a proper friction between the sleeve and the rotary shaft. However, it is difficult to perform the high precision of the components in manufacturing, therefore, a larger cost is needed for manufacturing this type of free stopping hinge.

Latterly, as an improvement, a friction element is provided, which is assembled between the sleeve and the rotary shaft, for controlling the friction force. Though these free stopping hinges can provide a desirable friction force between the sleeve and the rotary shaft, a disadvantage still exists, that is the complicated construction and assembling cannot adapt to the fields in which the simple structures and quick assembling of the device are more demanded and noticed.

Therefore, a type of free stopping hinge, which not only has a simple structure and can be assembled easily, but also can provide a proper friction, is strongly desired.

### SUMMARY OF THE INVENTION

Accordingly, an object of present invention is to provide a free stopping hinge in which a proper friction force can be generated for free stopping.

Another object of the present invention is to provide a free stopping hinge, which has simple structure and can be assembled easily.

To achieve above objects, the present invention provides a free stopping hinge including a sleeve and a rotary shaft. The sleeve has a mating portion with an axial hole defined therein. A wall of the hole has an axial slot and a perpendicular slot being perpendicular to and: communicating with the axial slot. Both of the axial slot and the perpendicular slot penetrate the wall of the axial hole. The rotary shaft has an engaging portion pivotally installed in the axial hole.

It can be seen from the mentioned-above that, the present free stopping hinge is composed of no special flexible fiction element, thereby has a simple structure. The axial slot and the perpendicular slot help to provide flexibility in engaging the shaft and the sleeve, thereby facilitating assembling of the hinge. The flexibility in turn helps to provide a proper friction as the rotary shaft rotates with respect to the sleeve for free stopping.

### BRIEF DESCRIPTION OF THE DRAWINGS

The present invention will be apparent to those skilled in the art by reading the following description of an embodiment thereof, with reference to the attached drawings, in which:

FIG. 1 is a perspective view of a free stopping hinge according to the present invention;

FIG. 2 is an exploded view of the free stopping hinge as shown in FIG. 1; and

FIG. 3 is a cross sectional view taken along the line III-III of FIG. 1.

### DETAILED DESCRIPTION OF THE PREFERRED EMBODIMENT

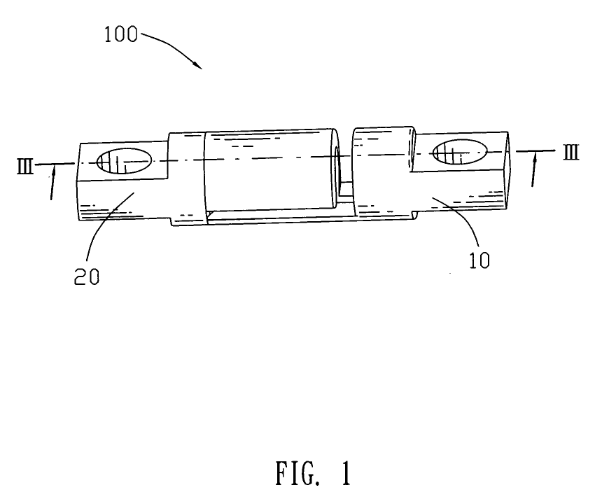

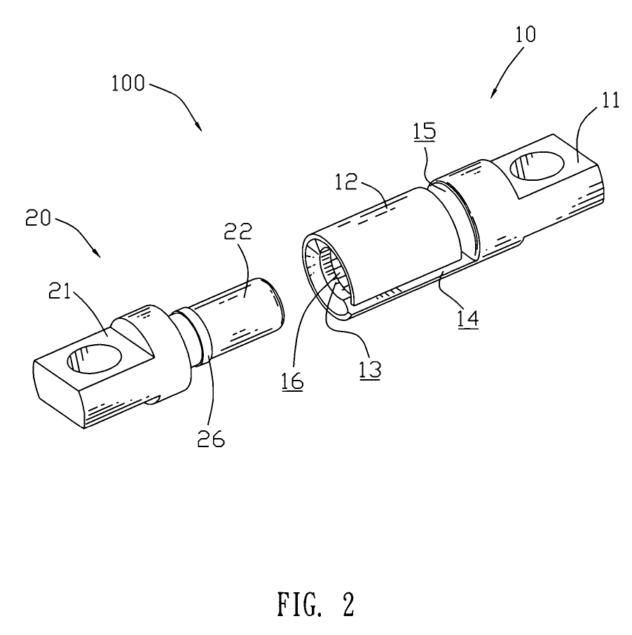

With reference to FIG. 1 and FIG. 2, a free stopping hinge 100 according to the present invention is illustrated. The free stopping hinge 100 includes a sleeve 10 and a rotary shaft 20 pivotally engaged with the sleeve 10.

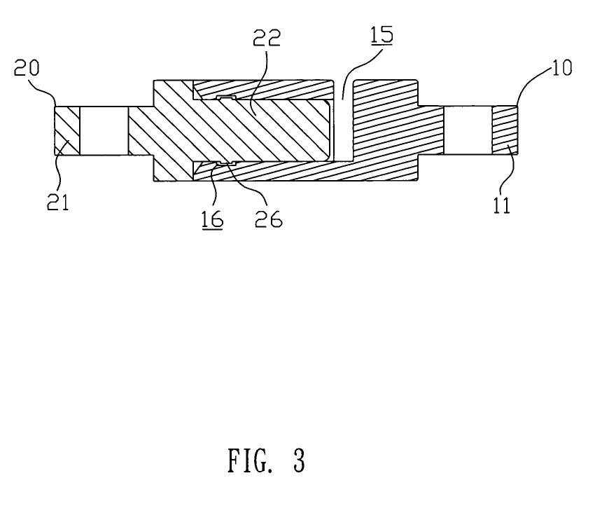

Referring to FIG. 2 in conjunction with FIG. 3, the sleeve 10 has a coupling portion 11 for connecting with a stator unit such as a mainframe in a notebook computer and a mating portion 12 opposite to the coupling portion 11 for mating with the rotary shaft 20. The mating portion 12 has an axial hole 13 axially defined therein. A wall of the axial hole 13 has an axial slot 14 and a perpendicular slot 15 being perpendicular to and communicating with the axial slot 14. Both of the axial slot 14 and the perpendicular slot 15 penetrate the wall of the axial hole 13. Thus with the construction described, the mating portion 12 of the sleeve 10 has flexibility and can be slightly deformed. An annular recess 16 is further defined in an inner surface of the wall of the hole 13.

Referring to FIG. 2 in conjunction with FIG. 3 again, the rotary shaft 20 for engaging with the sleeve 10 has a connecting portion 21 for connecting with a rotary unit such as a screen in the notebook computer and an engaging portion 22 opposite to the connecting portion 21 for engaging with the mating portion 12 of the sleeve 10. The engaging portion 22 is shaped as a cylinder, which is adapted to be pivotally installed in the axial hole 13 of the sleeve 10. An annular cam 26 is integrally formed around the engaging portion 22 for engaging with the recess 16 defined in the hole 13.

As described above, the axial slot 14 and the perpendicular slot 15 help to provide flexibility in engaging the rotary shaft 20 and the sleeve 10, therefore, the axial hole 13 is enlargeable so that the engaging portion 22 can be easily installed and rotate in the axial hole 13. Simultaneously, a resilient force provided by the mating portion 12 of the sleeve 10 is acted on the engaging portion 22. Therefore, as the rotary shaft 20 rotates with respect to the sleeve 10, a proper friction is generated due to the resilience.

Composed of no special friction element, the free stopping hinge 100 can be assembled easily by inserting the engaging portion 22 of the rotary shaft 20 into the axial hole 13 of the sleeve 10 to a position where the cam 26 is latched in the recess 16.

As mentioned above, one advantage of present invention is the free stopping hinge 100 has a simple structure and consequently has an easy assembling procedure. Another advantage of present invention is the free stopping hinge 100 can provide a proper friction force generated between the sleeve 10 and the rotary shaft 20 for free stopping.

Although a preferred embodiment of the present invention has been described in detail hereinabove, it should be clearly understood that many variations and/or modifications of the basic inventive concepts herein taught which may appear to those skilled in the present art will fall within the spirit and scope of the present invention, as defined in the appended claims.

What is claimed is:

1. A free stopping hinge comprising:
a sleeve having a mating portion with an axial hole defined therein, a wall of the hole having an axial slot and a perpendicular slot being perpendicular to and communicating with the axial slot, both of the axial slot and the perpendicular slot penetrating the wall of the axial hole; and
a rotary shaft having an engaging portion pivotally installed in said axial hole.

2. The free stopping hinge as claimed in claim 1, wherein said sleeve further has an annular recess defined in an inner surface of the wall of the axial hole, and said rotary shaft further has an annular projection formed around said engaging portion for engaging with the annular recess.

3. The free stopping hinge as claimed in claim 1, wherein said sleeve further has a coupling portion opposite to the mating portion, and said rotary shaft further has a connecting portion opposite to the engaging portion.
